(19) United States
(12) Patent Application Publication
(10) Pub. No.: US 2023/0206254 A1
(43) Pub. Date: Jun. 29, 2023

(54) Computer-Based Systems Including A Machine-Learning Engine That Provide Probabilistic Output Regarding Computer-Implemented Services And Methods Of Use Thereof

(71) Applicant: Capital One Services, LLC, McLean, VA (US)

(72) Inventors: Anh Truong, McLean, VA (US); Galen Rafferty, McLean, VA (US); Jeremy Goodsitt, Plano, TX (US); Vincent Pham, McLean, VA (US); Austin Walters, McLean, VA (US)

(21) Appl. No.: 17/561,701

(22) Filed: Dec. 23, 2021

(51) Int. Cl. G06Q 30/02; G06N 5/02

(52) U.S. Cl. CPC G06Q 30/0201; G06N 5/022

(57) ABSTRACT

Systems and methods of providing probabilistic recommendation(s) regarding computer-implemented service are disclosed. In one example, an illustrative system may comprise one or more computing components that are configured to obtain trial service information once a user begins a service and monitor related electronic activity of the user during the trial to collect user-specific service feature data, and a machine learning engine involved with the extraction of at least one user-specific feature vector from the user-specific service feature data. Further, the computing components may be configured to obtain and process such user-specific feature vector(s) in comparison against the feature data, and then determine and provide one or more trial-specific recommended options based on the comparison. Some implementations may also implement the machine-learning aspects in various automated ways, such as via automated processing based on at least one selection and/or other information received from the user.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in drawings that form a part of this document: Copyright, Capital One Services, LLC., All Rights Reserved.

### FIELD OF TECHNOLOGY

The present disclosure generally relates to improved computer-based platforms or systems, improved computer-implemented methods, and improved computing components and devices configured for one or more novel technological applications involving a machine learning engine that processes information regarding computer-implemented services and/or associated data.

### BACKGROUND OF TECHNOLOGY

A computer network platform/system may include a group of computers (e.g., clients, servers, computing clusters, cloud resources, etc.) and other computing hardware devices that are linked and communicate via software architecture, communication applications, and/or software applications associated with electronic transactions, subscriptions to or management of trial services, and/or associated data processing.

### SUMMARY OF DESCRIBED SUBJECT MATTER

In some embodiments, the present disclosure provides various exemplary technically improved computer-implemented systems involving machine learning that processes information associated with computer-implemented services and/or associated data, including systems comprising features such as:

at least one computer configured to: (i) obtain trial service information upon indication that a user started a service, the trial service information comprising data including two or more of: a period of time, a type of service, and a trial modality; and (ii) monitor related electronic activity of a user during the trial to collect user-specific service feature data;

a machine learning engine or server, which in some embodiments may involve natural language processing (NLP), configured to extract, via a machine learning model, at least one user-specific feature vector from the user-specific service feature data;

wherein the at least one computer is configured to:
obtain and process a plurality of feature vectors based at least in part on:
   (i) user-specific historical trial information of the user; and
   (ii) other service information associated with service trial activities of other users that bear a relationship to the trial, the user, or both;
compare the user-specific feature vector of the user with the plurality of feature vectors;
predict, based on the comparison, i) a user-specific predicted future usage of the service and ii) a user-specific future action regarding the service, the trial, or both;
determine a trial-specific recommended option based at least in part on the comparison;
provide, to a computing device associated with the user, a computer instruction configured to cause a user-specific graphical user interface to be displayed on a screen of the computing device, wherein the user-specific graphical user interface comprising a graphical user interface element allowing the user to select the trial-specific recommended option; and
automatically execute the trial-specific recommended option upon receiving an indication identifying the selection of the trial-specific recommended option by the user.

In some embodiments, the present disclosure provides various exemplary technically improved computer-implemented methods involving machine learning and processing information associated with computer-implemented services and/or associated data, including methods comprising one or more steps such as:

obtaining, by at least one computer, trial service information upon indication that a user started a trial of a service, the trial service information comprising data including two or more of: a trial period, service type information, and a trial modality;

monitoring, by the at least one computer, service-related electronic activity of the user during the trial to collect user-specific service feature data;

extracting, by the at least one computer, such as by utilizing one or both of a machine learning model or natural language processing (NLP), at least one user-specific feature vector from the user-specific service feature data;

obtaining, by the at least one computer, a plurality of feature vectors based at least in part on:
(i) user-specific historical trial information of the user and
(ii) other service information associated with service trial activities of other users that bear a relationship to the trial, the user, or both;

comparing, by the at least one computer, the user-specific feature vector of the user with the plurality of feature vectors;

predicting, by the at least one computer, based on the comparison, i) a user-specific predicted future usage of the service and ii) a user-specific future action regarding the service, the trial, or both;

determining, by the at least one computer, a trial-specific recommended option based at least in part on the comparison;

providing, by the at least one computer, to a computing device associated with the user, a computer instruction configured to cause a user-specific graphical user interface to be displayed on a screen of the computing device, wherein the user-specific graphical user interface comprising a graphical user interface element allowing the user to select the trial-specific recommended option; and

automatically executing, by the at least one computer, the trial-specific recommended option upon receiving an indication identifying the selection of the trial-specific recommended option by the user.

In some embodiments, the present disclosure also provides exemplary technically improved computer-readable media, including computer-readable media implemented with and/or involving one or more software applications, whether resident on personal and/or mobile computing devices, other computing devices or platforms, provided for download via a server and/or executed in connection with at least one network and/or connection, that include or involve features, functionality, computing components and/or steps consistent with those set forth herein.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram of an exemplary system and/or platform involving features of processing trial service information, consistent with exemplary aspects of certain embodiments of the present disclosure.

FIG. 2 is a block diagram of an exemplary online service system involving features of processing trial service information, consistent with exemplary aspects of certain embodiments of the present disclosure.

FIG. 3 is a block diagram of an exemplary computing device that may be associated with processing trial service information, consistent with exemplary aspects of certain embodiments of the present disclosure.

FIG. 4A is a block diagram illustrating an exemplary partner platform and machine learning engine that may be utilized in processing trial service information, consistent with exemplary aspects of certain embodiments of the present disclosure.

FIG. 4B is a flowchart illustrating one exemplary process related to processing trial service information, consistent with exemplary aspects of certain embodiments of the present disclosure.

FIG. 5 is a block diagram depicting an exemplary computer-based system and/or platform, consistent with exemplary aspects of certain embodiments of the present disclosure.

FIG. 6 is a block diagram depicting another exemplary computer-based system and/or platform, consistent with exemplary aspects of certain embodiments of the present disclosure.

FIGS. 7 and 8 are diagrams illustrating two exemplary implementations of cloud computing architecture/aspects with respect to which the disclosed technology may be specifically configured to operate, consistent with exemplary aspects of certain embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

As explained in more detail, below, various exemplary computer-based systems and methods of the present disclosure allow for improved monitoring and tracking of trial services engaged in by users, e.g., by utilizing machine learning, which may, in some embodiments, include or involve natural language processing (NLP), to analyze information and provide recommendations regarding continuing the service or trial. Embodiments include building a predictive model based on historical data associated with related trial usage information, generating predictions regarding likely usage of the service after the trial period ends, and providing outputs, such as recommendations or other actions associated with the predictions, continuing with the service, extending the trial, and the like.

In one example, an illustrative system may comprise one or more computing components that are configured to obtain trial service information once a user begins a service and monitor related electronic activity of the user during the trial to collect user-specific service feature data, and a machine learning engine involved with the extraction of at least one user-specific feature vector from the user-specific service feature data. Further, the computing components may be configured to obtain and process such user-specific feature vector(s) in comparison against the feature data, and then determine and provide a trial-specific recommended option based on the comparison. Some implementations may also execute such machine-learning options in various automated ways, such as via automated processing based on at least one selection and/or other information received from the user.

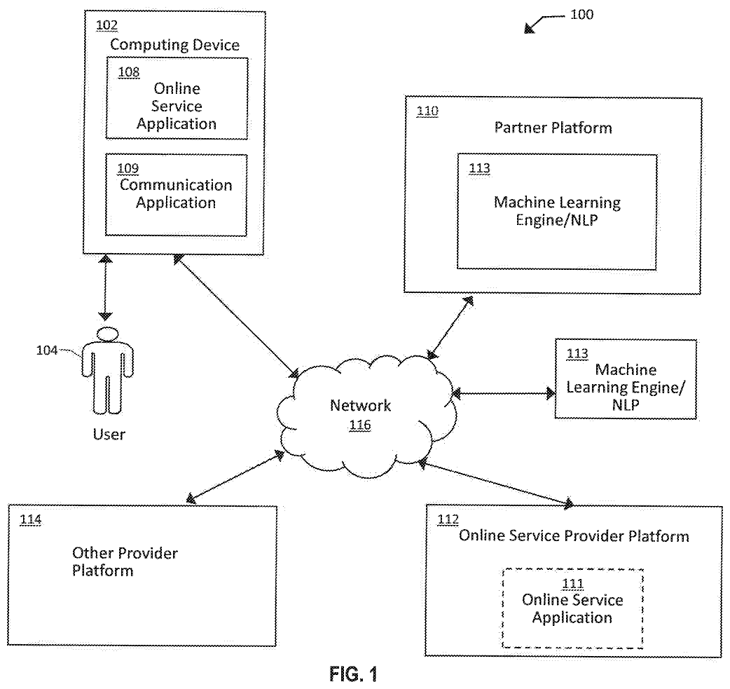

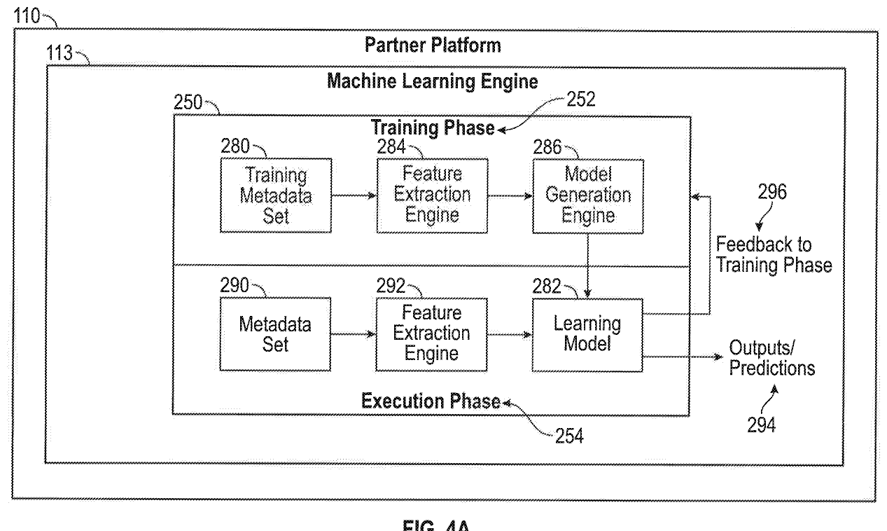

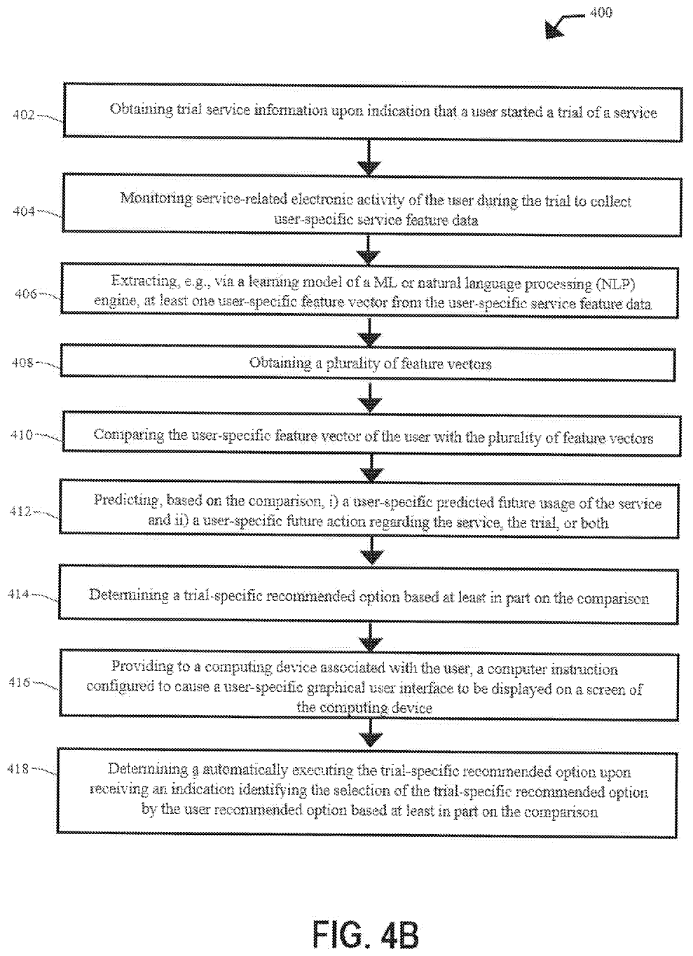

FIG. 1 is a block diagram of an exemplary system and/or platform involving features of processing trial service information, consistent with exemplary aspects of certain embodiments of the present disclosure. System 100, which may take the form of a platform, may be configured for executing one or more software applications and processing trial service information consistent with the disclosed embodiments. As shown, system 100 may include one or more computing devices 102, such as a client computing device associated with a user 104. Computing device 102 may be configured to execute, among other programs, an online service application 108 and a communication application 109. Other applications, e.g., other than the example online service application 108 illustrated and described below, provided to the users may also utilize the disclosed technology. As set forth in the example embodiment shown, system 100 may further include an online service provider computer platform 112, such as an enterprise company platform, a merchant platform, or any other provider platform that hosts online services for users over a network, one or more other provider systems 114, such as databases, providers or entities associated with the service(s) being provided or the trial service technology disclosed herein, and a partner platform 110 that assists the user with trials of online services, such partner platform 110 having one or more machine learning engines 113 associated therewith. The partner platform 110 is described in more detail, below, in connection with FIG. 4A. In some embodiments, the partner platform may comprise or be associated with one or more entities that provide, maintain, manage, or otherwise offer any services relating to payment transaction systems. In some embodiments, exemplary entity may be a financial service entity that provides, maintains, manages, or otherwise offers financial services. Such financial service entity may be a bank, credit card issuer, or any other type of financial service entity that generates, provides, manages, and/or maintains financial service accounts that entail assisting users with financial-related services and/or financial service accounts. Financial service accounts may include, for example, credit card accounts, bank accounts such as checking and/or savings accounts, reward or loyalty program accounts, debit account, and/or any other type of financial service account known to those skilled in the art.

As shown here in FIG. 1, computing device 102, online service provider platform 112, partner platform 110, and other provider platform 114 may be communicatively coupled by a network 116. Various functionality and benefits of online service application 108 and communication application 109 may also be achieved via one or more applications or modules, such as 111, within or associated with the online service provider platform 112. Here, for example, online service provider platform 112 may contain a server-side version of an online service application 111 affiliated with the client-side online service application 108 at the computing device 102. For simplicity of explanation, various communication and/or behavior of such computer systems and/or components (i.e., 108, 109 and 111) are generally discussed below by referring to operation of the online service application, generally.

Other provider platform 114 may be one or more computing devices accessed in connection with providing the online service application 111, such as information or programs requested by the online service provider platform 112 over network 116. For example, files or data used by the online service application 111 may be stored in a database of other provider platform 114, and/or other information needed to provide or perform the online service, or trial thereof, may be resident in one or more other provider platforms 114. In some embodiments, other provider platform 114 may be associated with a merchant that provides goods or services, other service providers, or other entities that provide online customer or user accounts. The disclosed embodiments are not limited to any particular configuration of other provider platform 114.

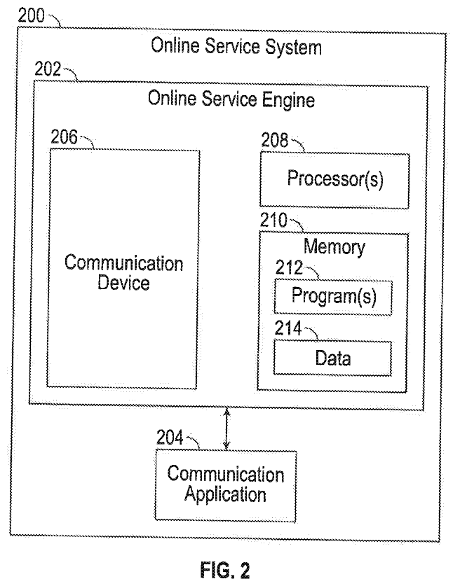

While only set quantity (typically one) of online service application 108, communication application 109, online service provider platform 112, partner platform 110, other provider platform 114, and network 116 are shown, it will be understood that system 100 may include more than one of any of these components. More generally, the components and arrangement of the components included in system 100 may vary. Thus, system 100 may include other components that perform or assist in the performance of one or more processes consistent with the disclosed embodiments. Computing device 102 may be one or more computing devices configured to perform operations consistent with executing online service application 108 and communication application 109. One illustrative computing device 102 is further described below in connection with FIG. 2.

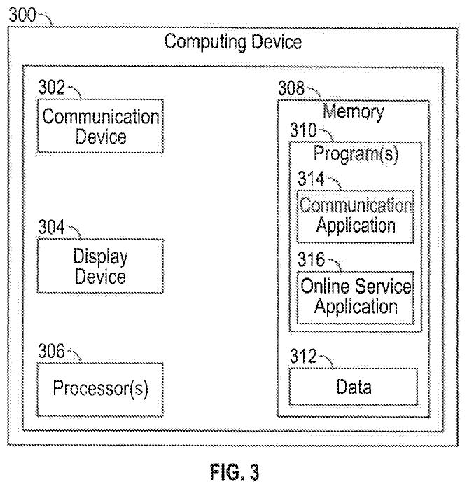

Online service application 108 may be one or more software applications configured to perform operations consistent with providing the online service and trials thereof, establishing accounts, processing account information and/or payment information, and/or other operations, either known or described or associated with the trial service processing herein, as well as obtaining and transmitting desired information between the online service application 111 and the user 104, and the like. Here, for example, online service application 108 may be configured to provide various information, such a limited duration trial of the online service application, to the user 104. Such processing may occur by or with an online service application 108, locally, or the online service application 108 may transmit requests to and/or operate with one or more other software applications and/or computing components to obtain and transmit the desired information. Online service application 108 may also be hosted and/or operated, in whole or in part, by a system and/or server, such as an online service provider platform 112. Online service application 108 is further described below in connection with the computing device 300 of FIG. 3.

Communication application 109 may be one or more software applications, modules, routines, subroutines and/or extensions configured to provide services for user 104 at client computing device 102. In some embodiments, communication application 109 may be integral with online service application 108. Communication application 109 may be configured to perform operations consistent with providing a trial service during performance of the online service on client computing device 102.

Online service provider platform 112 may be one or more computing devices configured to host one or more software applications consistent with providing one or more services to user 104. For example, online service provider platform 112 may provide online service application 108 at computing device 102 over network 116. In some embodiments, other provider platform 114 may also be hosting one or more software applications to provide services to user 104 at client computing device 102 over network 116. For example, the one or more software applications may involve various online services that enable access to secondary services or data which user 104 may utilize. In some embodiments, the online service provider 112 may be configured with an online service application 111 to manage and process access, logins, trials and other functionality for the service(s) and/or application(s) provided. In other embodiments, online service application 111 may be configured remotely from online service provider platform 112. Further, in some embodiments, the online service application 111 may be configured at other provider platform 114.

Network 116 may be any type of network configured to provide communication between components of system 100. For example, network 116 may be any type of network (including infrastructure) that provides communications, exchanges information, and/or facilitates the exchange of information, such as the Internet, a Local Area Network, near field communication (NFC), optical code scanner, or other suitable connection(s) that enables the sending and receiving of information between the components of system 100. In other embodiments, one or more components of system 100 may communicate directly through a dedicated communication link(s).

It is to be understood that the configuration and boundaries of the functional building blocks of system 100 have been defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

FIG. 2 is a block diagram of an exemplary online service system 200 that may correspond to or be associated with an online service provider 112 that provides a trial service, consistent with disclosed embodiments. As shown, online service system 200 may include online service engine 202, such as a server, and a communication application 204. Online service engine 202 may include a communication device 206, one or more processor(s) 208, and memory 210 including one or more programs 212 and data 214. Online service engine 202 may be configured to perform operations consistent with providing the online service application, which may be one of the programs 212, and trials thereof, as well as associated online service processing features and functionality herein.

Online service engine 202 may take the form of a server, general purpose computer, mainframe computer, or any combination of these components. Other implementations consistent with disclosed embodiments are possible as well. Communication application 204, e.g., a web browser application, browser extension application, etc., may take the form of one or more software applications stored on a computing device, such one or more software application stored in memory 210 or otherwise stored for access by an online service system 200 or the online service provider 112, described above.

Communication device 206 may be configured to communicate with one or more computing devices, such as user devices 102, or devices or databases associated with other provider systems 114, and the like. In some embodiments, communication device 206 may be configured to communicate with the computing device(s) through communication application 204. Online service engine 202 may, for example, be configured to provide instructions and/or operating information to communication application 204 through communication device 206. Communication device 206 may be configured to communicate other information as well.

Communication device 206 may be further configured to communicate with one or more systems associated with provide the online service and/or share information associated with the trial service, such as another online service provider 112, other provider platform 114, and the like. In some embodiments, such systems may operate or execute at least one software application that corresponds to the subject service application for trial, and communication device 206 may be configured to communicate with such systems to generate, transmit and/or process service, account and/or other information and instructions regarding the subject services. Communication device 206 may be configured to communicate with such system(s) in other ways. Communication device 206 may be configured to communicate with other components as well.

Processor(s) 208 may include one or more known processing devices, such as a microprocessor from the Core™, Pentium™ or Xeon™ family manufactured by Intel®, the Turion™ family manufactured by AMD™, the “Ax” (i.e., A6 or A8 processors) or “Sx” (i.e. S1, . . . processors) family manufactured by Apple™, or any of various processors manufactured by Sun Microsystems, for example. The disclosed embodiments are not limited to any type of processor(s) otherwise configured to meet the computing demands required of different components of online service system 200.

Memory 210 may include one or more storage devices configured to store instructions used by processor(s) 208 to perform functions related to disclosed embodiments. For example, memory 210 may be configured with one or more software instructions, such as program(s) 212, that may perform one or more operations when executed by processor(s) 208. Such operations may include managing online services, trials thereof, as well as creation, processing and/or transmission of associated information. The disclosed embodiments are not limited to separate programs or computers configured to perform dedicated tasks. For example, memory 210 may include a single program 212 that performs the functions of online service system 200, or program(s) 212 may comprise multiple programs. Memory 210 may also store data 214 that is used by program(s) 212.

In certain embodiments, memory 210 may store one or more sets of instructions involved with carrying out the processes described below. Other instructions are possible as well. In general, instructions may be executed by processor(s) 208 to perform one or more processes consistent with disclosed embodiments. In some embodiments, program(s) 212 may include one or more subcomponents configured to generate and/or process instructions and information for use by communication application 204 the online service applications 108, 111 in performing account establishment, initiating trial of a service, and other activities associated with the online service processing features and functionality herein.

The components of online service system 200 may be implemented in hardware, software, or a combination of both hardware and software, as will be apparent to those skilled in the art. For example, although one or more components of online service system 200 may be implemented as computer processing instructions, all or a portion of the functionality of online service system 200 may be implemented instead in dedicated electronics hardware. In some embodiments, online service system 200 may also be communicatively connected to one or more database(s) (not shown). Alternatively, such database(s) may be located remotely from online service system 200. Online service system 200 may be communicatively connected to such database(s) through a network, such as network 116 described above. Such database(s) may include one or more memory devices that store information and are accessed and/or managed through online service system 200. By way of example, such database(s) may include Oracle™ databases, Sybase™ databases, or other relational databases or non-relational databases, such as Hadoop sequence files, HBase, or Cassandra. Such database(s) may include computing components (e.g., database management system, database server, etc.) configured to receive and process requests for data stored in memory devices of the database(s) and to provide data to the database(s).

FIG. 3 is a block diagram of an exemplary computing device 300, such as user device 102, consistent with disclosed embodiments. As shown, computing device 300 may include communication device 302, display device 304, processor(s) 306, and memory 308 including program(s) 310 and data 312. Program(s) 310 may include, among others, communication application 314 and online service application 316. In some embodiments, computing device 300 may take the form of a desktop or mobile computing device or IoT device, such as a desktop computer, laptop computer, smartphone, tablet, any combination of these components. Alternatively, computing device 300 may be configured as other fixed, portable, and/or mobile device, and/or wearable device, and/or any other device suitable for carrying on a user's person. Other implementations consistent with disclosed embodiments are possible as well. Computing device 300 may, for example, be the same as or similar to computing device 102 described above.

In the example embodiment shown, communication device 302 may be configured to communicate via one or more networks with the various computer systems and servers disclosed herein, such as online service provider 112. In some embodiments, communication device 302 may be further configured to communicate with one or more other providers, such as other provider platform(s) 114 described above. Communication device 302 may be configured to communicate with other components as well. Communication device 302 may be configured to provide communication over a network, such as network 116 described above. To this end, communication device 302 may include, for example, one or more digital and/or analog devices that allow computing device 300 to communicate with and/or detect other components, such as a network controller and/or wireless adaptor for communicating over the Internet. Other implementations consistent with disclosed embodiments are possible as well.

Display device 304 may be any display device configured to display interfaces on computing device 300. The interfaces may be configured, e.g., for online service-related information provided by computing device 300 via online service application 108. In some embodiments, display device 304 may include a screen for displaying a graphical and/or text-based user interface, including but not limited to, liquid crystal displays (LCD), light emitting diode (LED) screens, organic light emitting diode (OLED) screens, and other known display devices. In some embodiments, display device 304 may also include one or more digital and/or analog devices that allow a user to interact with computing device 300, such as a touch-sensitive area, keyboard, buttons, or microphones. Other display devices are possible as well. The disclosed embodiments are not limited to any type of display devices otherwise configured to display interfaces.

Processor(s) 306 may include one or more known processing devices, such as a microprocessor from the Core™, Pentium™ or Xeon™ family manufactured by Intel™, the Turion™ family manufactured by AMD™, the “Ax” or “Sx” family manufactured by Apple™, or any of various processors manufactured by Sun Microsystems, for example. The disclosed embodiments are not limited to any type of processor(s) otherwise configured to meet the computing demands required of different components of computing device 300.

Memory 308 may include one or more storage devices configured to store instructions used by processor(s) 306 to perform functions related to disclosed embodiments. For example, memory 308 may be configured with one or more software instructions, such as program(s) 310, that may perform one or more operations when executed by processor(s) 306. The disclosed embodiments are not limited to separate programs or computers configured to perform dedicated tasks. For example, memory 308 may include a single program 310 that performs the functions of computing device 300, or program(s) 310 may comprise multiple programs. Memory 308 may also store data 312 that is used by program(s) 310. In certain embodiments, memory 308 may store sets of instructions for carrying out some processes performed in connection with implementations described herein. Other instructions are possible as well. In general, instructions may be executed by processor(s) 306 to perform one or more processes consistent with disclosed embodiments.

In some embodiments, program(s) 310 may include a communication application 314. Communication application 314 may be executable by processor(s) 306 to perform operations including, for example, communicating information and/or performing other communications associated with the online service and trials thereof. Such communications may be processed by processor(s) 306 as well as displayed, for example, via display device 304. In some embodiments, such communications may be associated with systems, such as online service provider 112, other provider platform 114, and the like, described above. Communication application 314 may be executable by processor(s) 306 to perform other operations as well. In some embodiments, program(s) 310 may further include an online service application 316 which may implement aspects of secure account sharing, and otherwise provide web pages and execute programs, applications, and/or modules associated with the online service. This online service application 316 may, for example, be a program or module corresponding to the online service application 111 described above. Online service application 316 may be executable by processor(s) 306 to perform various operations including, for example, providing the online service and trials thereof, establishing accounts, processing account information and/or payment information, and/or otherwise known or described or associated with the trial service processing herein and/or accessed by computing device 300 via online service program 316. Other instructions are possible as well. In general, instructions may be executed by processor(s) 306 to perform one or more processes consistent with disclosed embodiments.

The components of computing device 300 may be implemented in hardware, software, or a combination of both hardware and software, as will be apparent to those skilled in the art. For example, although one or more components of computing device 300 may be implemented as computer processing instructions, all or a portion of the functionality of computing device 300 may be implemented instead in dedicated electronics hardware.

FIG. 4A is a block diagram of exemplary partner platform 110 including details of an illustrative machine learning engine 113, consistent with exemplary aspects of certain embodiments of the present disclosure. Referring to the exemplary partner platform 110 and computing components set forth in FIGS. 1 through 4A, an exemplary system herein may comprise: at least one computer configured to (i) obtain trial service information upon indication that a user started a service, the trial service information comprising data including two or more of: a period of time, a type of service, and a trial modality, and (ii) monitor related electronic activity of a user during the trial to collect user-specific service feature data; and a machine learning engine 113 or server(s), which may utilize natural language processing (NLP), configured to extract, via a machine learning model, such as illustrative machine learning model 282, at least one user-specific feature vector from the user-specific service feature data. Further, according to embodiments herein, the at least one computer may be configured to: obtain and process a plurality of feature vectors based at least in part on (i) user-specific historical trial information of the user, and/or (ii) other service information associated with service trial activities of other users that bear relationship to the trial, to the user, or to both; compare the user-specific feature vector of the user with the plurality of feature vectors; predict, based on the comparison, (i) a user-specific predicted future usage of the service and (ii) a user-specific future action regarding the service and/or the trial; determine a trial-specific recommended option based at least in part on the comparison; provide, to a computing device associated with the user, a computer instruction configured to cause a user-specific graphical user interface to be displayed on a screen of the computing device, wherein the user-specific graphical user interface comprising a graphical user interface element allowing the user to select the trial-specific recommended option; and automatically execute the trial-specific recommended option upon receiving an indication identifying the selection of the trial-specific recommended option by the user.

FIG. 4A includes an illustrative machine learning engine or model, at 113, consistent with various aspects of the disclosed technology. As shown in FIG. 4A, exemplary machine learning processing, at 250, may include a training phase 252 which trains a machine learning model and an execution phase 254 which uses the machine learning model to process user-specific feature vectors associated with the user and/or trial, and provide the associated outputs discussed herein, such as predictions or recommendations regarding trial usage.

As shown herein, in some embodiments, the training phase 252 builds the illustrative machine learning model 282 for a collection of metadata items. A collection of metadata items is a collection of metadata generated based on or pertaining to various data items accessible to the partner platform 110. In some embodiments, for example, a collection of metadata items may be associated with a particular user, a particular group of users, a particular service, a particular trial of a service, a particular service entity, and the like. The training phase 252 may utilize a training metadata dataset 280, a feature extraction engine 284, and a model generation engine 286.

The training metadata dataset 280 is a corpus of metadata records obtained or otherwise identified or recognized with regard to a multitude of data, for example, those obtained from various data sources described herein, such as historical data, communications such as emails, financial information, service information, trial information, other information related to the user, others users, and the subject or related services, and the like. The training dataset 280 may comprise training data related to the general population of users, a particular user (e.g., user's accounts), or a group of users (e.g., users' accounts). The training dataset 280 may be generated via the partner platform 110, or obtained from a third party which warehouses and services user data for various purposes such as machine learned model generation. In such cases, the training metadata dataset 280 may be stored as a cloud or web service that is accessible to various parties through online transactions over a network.

Referring to the exemplary embodiment of FIG. 4A, the feature extraction engine 284 may be configured to extract features from the metadata training set to train the illustrative machine learning model 282. According to at least some embodiments herein, the illustrative machine learning model 282 may be trained in a supervised manner, a semi-supervised manner, and/or an unsupervised manner. In some implementations, the illustrative machine learning model 282 may utilize various techniques, such as linear regression, random forest, xgboost, svm, k-nearest neighbors, and/or may comprise analysis of time-series behavior involving one or both of DTW (dynamic time warping) or recurrent neural network processing. In one illustrative embodiment, for example, systems and methods herein may be implemented via xgboost modeling that utilizes multiple trees using gradient boosting technique(s) in order to generalize and learn from the historical user data. In some embodiments, clustering techniques may be utilized to find the similarity on behaviors among the groups of users. Here, for example, such clustering techniques include and/or involve, though are not limited to, k-means, and DBSCAN, among others.

Further, in some embodiments, the feature extraction engine 284 may transform the features into feature vectors with, for example, an annotation and/or a software tag that indicates whether or not a feature vector corresponds to an output, such as a prediction or recommendation. In some embodiments, the feature vector(s) may represent one or more changes in respective metadata. The feature vectors may then be utilized to train and test the feature model to detect the likelihood or probability regarding continuation of a trial service for the user. In some embodiments, the feature vectors may be partitioned into two subsets such that one subset is used to train the machine learning model and the second subset is used to test the machine learning model. In some implementations, the machine learning model may be trained and tested repeatedly until the machine learning model can perform detection and/or provide recommendations with a pre-configured confidence and error tolerance.

In some embodiments, the illustrative machine learning model 282 may be a classification model. Here, for example, such classification model may be utilized to predict and/or label various inputs of a user's metadata. In some embodiments, the illustrative machine learning model 282 may be configured as a classification model, such as, without limitation, a discrete tree classifier, a random tree classifier, a neural network, a support vector machine, a naive Bayes classifier, and the like. In some embodiments, the illustrative machine learning model 282 may be a gradient boost classification model generated. Such gradient boost classification may provide prediction of probabilities which enable the recommendations to be ranked. In some embodiments, the illustrative machine learning model 282 may comprise one or more cascade-based models for providing recommendations via multiple stages. Each stage may be associated with a stage specific model and a stage specific detection threshold such as risk (e.g., user interest, cost, etc.).

In the illustrative embodiment of FIG. 4A, the execution phase 254 may apply the illustrative machine learning model 282 to a set of metadata 290 scanned from data items relating to the user, the trial, and/or the service, including data items related to the user's account(s). In some embodiments, the feature extraction engine 292 may generate feature vectors having features that represent different manifestations of probabilities in the set of metadata. Such illustrative machine learning model 282 may then utilize the feature vectors to assign scoring or risk level(s) to the set of metadata. In some embodiments, such illustrative machine learning model 282 may draw a conclusion, based on the score or risk level exceeding a pre-configured threshold level or a machine learned threshold level, that there is a significant probability of an expected result in the set of metadata 290 to provide a determined output, at 294, e.g., recommendations, predictions and/or conclusions, such as one or more trial-specific recommended option(s). In general, the machine learning processing 250 may yield various outputs, such as determining a predicted usage and/or providing one or more recommended options. In providing these and other outputs, embodiments herein may also compare feature vectors of users associated with a plurality of services other than the service of the trial.

With regard to providing a prediction as an output, implementations herein may be configured to predict a trial of a new service to the user based on the vector of features of the user. According to other embodiments herein, an output may comprise trial-specific recommended option(s) including a recommendation for proceeding based on the predicted usage, wherein the recommended option is determined via assessing potential options comprised of proceeding with the service, canceling the trial, and extending the trial. Further, in some aspects, the recommended option may comprise at least an option for: an extension duration for the trial of the service, an amount of cost discount for a subscription to the service, and/or an upgrade option to the service.

In some embodiments, such illustrative machine learning model 282 may further associate a rationale for the recommendation, prediction or conclusion. A rationale supporting such recommendation, prediction or conclusion may include a single feature in the feature vector that is dispositive of the detection (e.g., given a particular behavior of the user), a combination of features, or an ordered or otherwise structured combination of features that contribute to such conclusion. In some embodiments, the rationale and a verification result of the detected item is fed back 296 to the training phase 252 to retrain the illustrative machine learning model 282.

In the machine learning processing 250, the feature extraction 284/292 and/or modeling 282/286, may involve processing one or both of feature vectors and/or user-specific service feature data. Here, for example, such feature vectors may include data such as: a pattern of usage, tendency regarding responsiveness to promotional materials offered, tendency to invite another user to try the service, frequency of service usage, recency of usage, whether or not the user checks the service subscriptions/prices via certain means, such as through the link provided in the service, and the like. According to some embodiments, obtaining and processing the plurality of feature vectors may include accessing a collection of electronic communication messages associated with the user, and parsing electronic communication messages in the collection to identify the indication that the user has started the trial of the service.

Feature extraction 284/292 and/or modeling 282/286 within the machine learning processing 250 may also involve processing user-specific service feature data. Here, for example, such user-specific service feature data may include information such as: extent that the service is accessed or used during the trial, quantity of user logins, length of the user logins, parameters of the logins (e.g., login time, login date, a login IP address, etc.), transaction/spending activity associated with the logins including one or both of quantity of actions and/or range or extent (e.g., cost-wise) of the actions, non-spending activity associated with the logins, and other customer-specific usage activity or parameters associated with logins, activity, use, and the like.

With regarding to the inputs and data obtained and processed, embodiments of the machine learning engine 113 may be configured to process actions associated with access to the service, including at least one of: a purchase transaction, a fund transfer action, an upgrade action, a viewing action, a click-through action on a recommended service item, an action by the user associated with changing type of or access to the service, an action by the user associated with terminating the service, an action by the user associated with putting the service on hold, and/or other actions and activity associated with access to and/or use of the service. Additionally, according to implementations herein, the machine learning engine 113 may be configured to process service trial activities of other users that bear relation to the trial or the user, such as activities associated with individuals who have one or more of: (i) started trials of the service in the past, (ii) subscribed to the service in the past, and/or (iii) accepted extension of trials of the service in the past. Further, in some embodiments, the partner platform 110 and/or one or more computing components, such as the computing device 102 associated with a user 104, may implement a browser extension application to obtain various information set forth herein, such as one or both of the trial service information or the user features.

FIG. 4B is a flowchart illustrating one exemplary process related to processing trial service information, consistent with exemplary aspects of at least some embodiments of the present disclosure. As shown in the exemplary flowchart of FIG. 4B, an illustrative trial service recommendation process 400 may comprise: obtaining trial service information upon indication that a user started a trial of a service, at 402; monitoring service-related electronic activity of the user during the trial to collect user-specific service feature data, at 404; extracting, such as via utilizing a machine learning model, e.g., associated with and/or involving a machine learning engine, a natural language processing (NLP) engine, etc., at least one user-specific feature vector from the user-specific service feature data, at 406; obtaining a plurality of feature vectors, at 408; comparing the user-specific feature vector of the user with the plurality of feature vectors, at 410; predicting, based on the comparison, i) a user-specific predicted future usage of the service and ii) a user-specific future action regarding the service, the trial, or both, at 412; determining a trial-specific recommended option based at least in part on the comparison, at 414; providing to a computing device associated with the user, a computer instruction configured to cause a user-specific graphical user interface to be displayed on a screen of the computing device, at 416; and automatically executing the trial-specific recommended option upon receiving an indication identifying the selection of the trial-specific recommended option by the user, at 418. Further, the trial service recommendation process 400 may be carried out, in whole or in part, online, e.g. via a Web or other network connection, and/or it may be carried out by in conjunction with browser extension functionality, such as being performed in connection with a browser extension application, e.g., the browser extension application described herein.

In some embodiments, the trial service recommendation process 400 may include, at 402, a step of obtaining trial service information upon indication that a user started a trial of a service. According to various aspects of the disclosure, the trial service information may comprise data including one or more of: a trial period, service type information; and/or a trial modality. Further, the trial service recommendation process 400 may be performed via at least one computer, such as an online computer, an online server, an online computer platform, and the like. Here, in some embodiments, the at least one computer may be part of a financial service provider (FSP) system, which may correspond to the partner platform. This FSP system may comprise one or more servers and/or processors associated with a financial service entity that provides, maintains, manages, or otherwise offers financial services. Such financial service entity may include a bank, credit card issuer, or any other type of financial service entity that generates, provides, manages, and/or maintains financial service accounts for one or more customers. In some embodiments, the information regarding the trial may be identified by identifying information relating to a service name, a service duration, and/or service cost. In some embodiments, the information regarding the trial may be obtained via a browser extension application.

Various embodiments herein may be configured to obtain an indication that the user started a trial of a service. In one example, such indication may be obtained by accessing a collection of electronic communication messages associated with the user; and/or parsing electronic communication messages in the collection to identify the indication that the user has started the trial of the service. The partner platform 110, such as a FSP, may also access payment or credit card information provided to initiate such trial service.

The trial service recommendation process 400 may include, at 404, a step of monitoring service-related electronic activity of the user during the trial to collect user-specific service feature data. In some embodiments, the user-specific service feature data may comprise various data such as one or more of: the extent that the service is used during the trial, quantity of user logins, length of the user logins, parameters of the logins (login time, login date, a login IP address, etc.), transaction and/or spending activity associated with the logins including one or both of: quantity of actions and/or a range or extent, cost-wise, of the actions, and non-spending activity associated with the logins, and/or any of the other user-specific service feature data set forth above or elsewhere herein. In some embodiments, the actions associated with access to the service may comprise at least one of: a purchase transaction, a fund transfer action, an upgrade action, a viewing action, a click-through action on a recommended service item, an action by the user associated with changing type of or access to the service, an action by the user associated with terminating the service, an action by the user associated with putting the service on hold, and/or other actions and activity associated with access to and/or use of the service, and/or any other such actions or activity set forth above and/or elsewhere herein.

The trial service recommendation process 400 may include, at 406, a step of extracting, such as by utilizing a machine learning model, e.g., associated with a machine learning or a natural language processing (NLP) engine, at least one user-specific feature vector from the user-specific service feature data. According to various aspects of the disclosure, the feature vector may include a pattern of usage, a tendency to respond to promotional materials offered, a tendency to invite another user to try the service, frequency of service usage, recency of usage, whether or not the user checks the service subscriptions/prices via certain means, such as through the link provided in the service, and the like. In various embodiments, the machine learning model may comprise analysis of time-series behavior involving one or both of DTW (dynamic time warping) or recurrent neural network processing.

The trial service recommendation process 400 may include, at 408, a step of obtaining a plurality of feature vectors. In some embodiments, the plurality of feature vectors may be obtained based at least in part on one or both of: (i) user-specific historical trial information of the user; and/or (ii) other service information associated with service trial activities of other users that bear a relationship to the trial, the user, or both. According to various aspects of the disclosure, the extracting the feature vector for the user may further comprise other techniques and functionality set forth herein, such as, in one embodiment, implementing the machine learning model such that it involves invocation of an xgboost model/function that utilizes multiple trees using gradient boosting technique(s) in order to generalize and learn from the historical user data. Here, for example, the service trial activities of the other users that bear relation to the trial or the user may include activities associated with individuals who have one or more of: (i) started trials of the service in the past, (ii) subscribed to the service in the past, and/or (iii) accepted extension of trials of the service in the past.

The trial service recommendation process 400 may include, at 410, a step of comparing the user-specific feature vector of the user with the plurality of feature vectors; at 412, a step of predicting, based on the comparison, i) a user-specific predicted future usage of the service and ii) a user-specific future action regarding the service, the trial, or both. In some embodiments, the determining the predicted usage may further comprise comparing feature vectors of users associated with a plurality of services other than the service of the trial; and at 414, a step of determining a trial-specific recommended option based at least in part on the comparison. In various embodiments, the trial-specific recommended option may comprise a recommendation for proceeding based on the predicted usage. Here, for example, the recommended option may be determined via assessing potential options comprised of proceeding with the service, canceling the trial, and extending the trial. In some embodiments, the recommended option may comprise at least an option for: an extension duration for the trial of the service, an amount of cost discount for a subscription to the service, and/or an upgrade option to the service. In one example, the providing the recommended option may further comprise comparing feature vectors of users associated with a plurality of services other than the service of the trial.

The trial service recommendation process 400 may include, at 416, a step of providing to a computing device associated with the user, a computer instruction configured to cause a user-specific graphical user interface to be displayed on a screen of the computing device. In some embodiments, the user-specific graphical user interface may comprise a graphical user interface element allowing the user to select the trial-specific recommended option.

The trial service recommendation process 400 may include, at 418, a step of automatically executing the trial-specific recommended option upon receiving an indication identifying the selection of the trial-specific recommended option by the user.

According to some embodiments, the methods disclosed herein may also comprise predicting a trial of a new service to the user based on the vector of features of the user. According to other embodiments, the methods disclosed herein may also comprise implementing a browser extension application to obtain one or both of the trial service information or the user features.

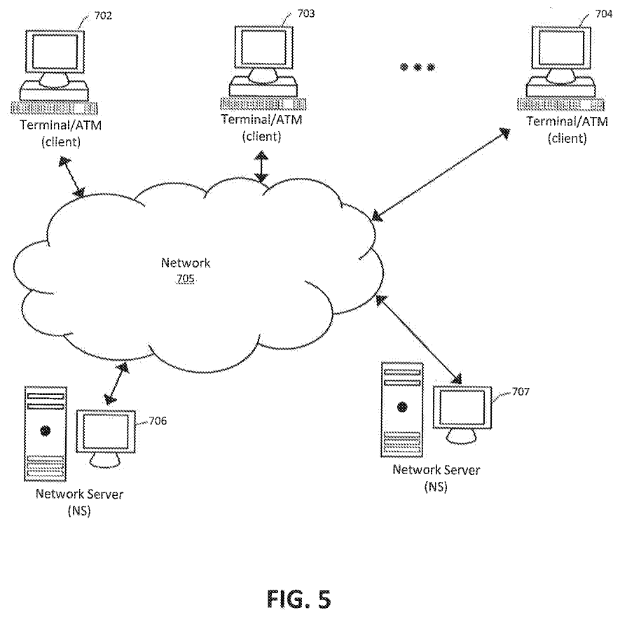

FIG. 5 depicts a block diagram of an exemplary computer-based system/platform in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the exemplary inventive computing devices and/or the exemplary inventive computing components of the exemplary computer-based system/platform may be configured to manage a large number of instances of software applications, users, and/or concurrent transactions, as detailed herein. In some embodiments, the exemplary computer-based system/platform may be based on a scalable computer and/or network architecture that incorporates varies strategies for assessing the data, caching, searching, and/or database connection pooling. An example of the scalable architecture is an architecture that is capable of operating multiple servers.

In some embodiments, referring to FIG. 5, members 702 through 704 (e.g., client or user devices) of the exemplary computer-based system/platform may include virtually any computing device capable of receiving and sending a message over a network (e.g., cloud network), such as network 705, to and from another computing device, such as servers 706 and 707, each other, and the like. In some embodiments, the member devices 702-704 may be personal computers, multiprocessor systems, microprocessor-based or programmable consumer electronics, network PCs, and the like. In some embodiments, one or more member devices within member devices 702-704 may include computing devices that typically connect using wireless communications media such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 702-704 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 702-704 may include one or more applications, such as Internet browsers, mobile applications, voice calls, video games, videoconferencing, and email, among others. In some embodiments, one or more member devices within member devices 702-704 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 702-704 may be specifically programmed by either Java, .Net, QT, C, C++ and/or other suitable programming language. In some embodiments, one or more member devices within member devices 702-704 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 705 may provide network access, data transport and/or other services to any computing device coupled to it. In some embodiments, the exemplary network 705 may include and implement at least one specialized network architecture that may be based at least in part on one or more standards set by, for example, without limitation, GlobalSystem for Mobile communication (GSM) Association, the Internet Engineering Task Force (IETF), and the Worldwide Interoperability for Microwave Access (WiMAX) forum. In some embodiments, the exemplary network 705 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 705 may include and implement, as an alternative or in conjunction with one or more of the above, a WiMAX architecture defined by the WiMAX forum. In some embodiments and, optionally, in combination of any embodiment described above or below, the exemplary network 705 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 705 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 705 may also include mass storage, such as network attached storage (NAS), a storage area network (SAN), a content delivery network (CDN) or other forms of computer- or machine-readable media.

In some embodiments, the exemplary server 706 or the exemplary server 707 may be a web server (or a series of servers) running a network operating system, examples of which may include but are not limited to Microsoft Windows Server, Novell NetWare, or Linux. In some embodiments, the exemplary server 706 or the exemplary server 707 may be used for and/or provide cloud and/or network computing. Although not shown in FIG. 5, in some embodiments, the exemplary server 706 or the exemplary server 707 may have connections to external systems like email, SMS messaging, text messaging, ad content providers, etc. Any of the features of the exemplary server 706 may be also implemented in the exemplary server 707 and vice versa.

In some embodiments, one or more of the exemplary servers 706 and 707 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 701-704.

In some embodiments and, optionally, in combination of any embodiment described above or below, for example, one or more exemplary computing member devices 702-704, the exemplary server 706, and/or the exemplary server 707 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

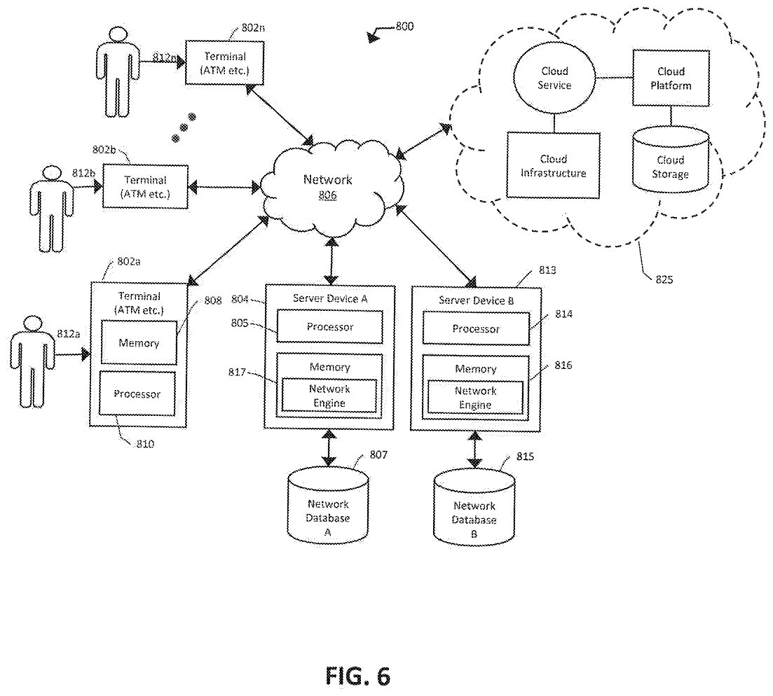

FIG. 6 depicts a block diagram of another exemplary computer-based system/platform 800 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices (e.g., POS devices) 802a, 802b through 802n shown each at least includes computer-readable media, such as a random-access memory (RAM) 808 coupled to a processor 810 and/or memory 808. In some embodiments, the processor 810 may execute computer-executable program instructions stored in memory 808. In some embodiments, the processor 810 may include a microprocessor, an ASIC, and/or a state machine. In some embodiments, the processor 810 may include, or may be in communication with, media, for example computer-readable media, which stores instructions that, when executed by the processor 810, may cause the processor 810 to perform one or more steps described herein. In some embodiments, examples of computer-readable media may include, but are not limited to, an electronic, optical, magnetic, or other storage or transmission device capable of providing a processor, such as the processor 810 of client 802a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other media from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 802a through 802n may also comprise a number of external or internal devices such as a mouse, a CD-ROM, DVD, a physical or virtual keyboard, a display, a speaker, or other input or output devices. In some embodiments, examples of member computing devices 802a through 802n (e.g., clients) may be any type of processor-based platforms that are connected to a network 806 such as, without limitation, personal computers, digital assistants, personal digital assistants, smart phones, pagers, digital tablets, laptop computers, Internet appliances, and other processor-based devices. In some embodiments, member computing devices 802a through 802n may be specifically programmed with one or more application programs in accordance with one or more principles/methodologies detailed herein. In some embodiments, member computing devices 802a through 802n may operate on any operating system capable of supporting a browser or browser-enabled application, such as Microsoft™ Windows™, and/or Linux. In some embodiments, member computing devices 802a through 802n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 802a through 802n, users, 812a through 812n, may communicate over the exemplary network 806 with each other and/or with other systems and/or devices coupled to the network 806.

As shown in FIG. 6, exemplary server devices 804 and 813 may be also coupled to the network 806. In some embodiments, one or more member computing devices 802a through 802n may be mobile clients. In some embodiments, server devices 804 and 813 shown each at least includes respective computer-readable media, such as a random-access memory (RAM) coupled to a respective processor 805, 814 and/or respective memory 817, 816. In some embodiments, the processor 805, 814 may execute computer-executable program instructions stored in memory 817, 816, respectively. In some embodiments, the processor 805, 814 may include a microprocessor, an ASIC, and/or a state machine. In some embodiments, the processor 805, 814 may include, or may be in communication with, media, for example computer-readable media, which stores instructions that, when executed by the processor 805, 814, may cause the processor 805, 814 to perform one or more steps described herein. In some embodiments, examples of computer-readable media may include, but are not limited to, an electronic, optical, magnetic, or other storage or transmission device capable of providing a processor, such as the respective processor 805, 814 of server devices 804 and 813, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other media from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, etc.

In some embodiments, at least one database of exemplary databases 807 and 815 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

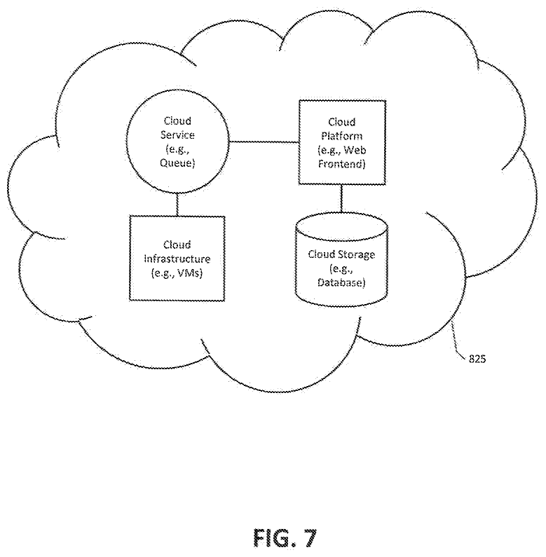

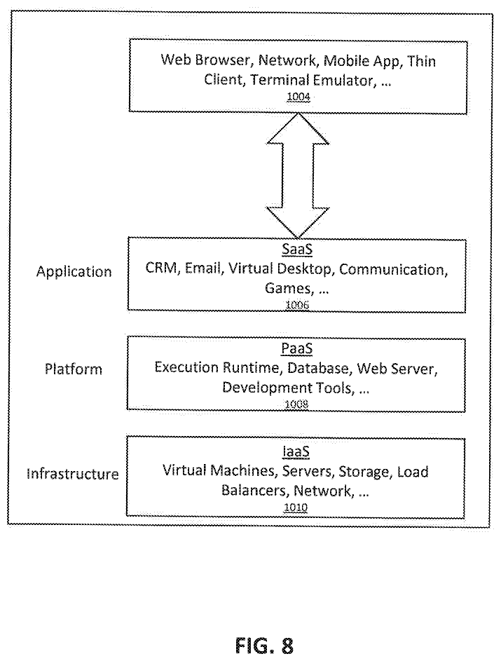

As also shown in FIGS. 7 and 8, some embodiments of the disclosed technology may also include and/or involve one or more cloud components 825, which are shown grouped together in the drawing for sake of illustration, though may be distributed in various ways as known in the art. Cloud components 825 may include one or more cloud services such as software applications (e.g., queue, etc.), one or more cloud platforms (e.g., a Web front-end, etc.), cloud infrastructure (e.g., virtual machines, etc.), and/or cloud storage (e.g., cloud databases, etc.).

According to some embodiments shown by way of one example in FIG. 8, the exemplary inventive computer-based systems/platforms, the exemplary inventive computer-based devices, components and media, and/or the exemplary inventive computer-implemented methods of the present disclosure may be specifically configured to operate in or with cloud computing/architecture such as, but not limiting to: infrastructure a service (IaaS) 1010, platform as a service (PaaS) 1008, and/or software as a service (SaaS) 1006. FIGS. 7 and 8 illustrate schematics of exemplary implementations of the cloud computing/architecture(s) in which the exemplary inventive computer-based systems/platforms, the exemplary inventive computer-implemented methods, and/or the exemplary inventive computer-based devices, components and/or media of the present disclosure may be specifically configured to operate. In some embodiments, such cloud architecture 1006, 1008, 1010 may be utilized in connection with the Web browser and browser extension aspects, shown at 1004, to achieve the innovations herein.

As used in the description and in any claims, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud components (e.g., FIG. 7-8) and cloud servers are examples.

In some embodiments, as detailed herein, one or more of exemplary inventive computer-based systems/platforms, exemplary inventive computer-based devices, and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a tweet, a map, an entire application (e.g., a calculator), etc. In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) AmigaOS, AmigaOS 4; (2) FreeBSD, NetBSD, OpenBSD; (3) Linux; (4) Microsoft Windows; (5) OpenVMS; (6) OS X (Mac OS); (7) OS/2; (8) Solaris; (9) Tru64 UNIX; (10) VM; (11) Android; (12) Bada; (13) BlackBerry OS; (14) Firefox OS; (15) iOS; (16) Embedded Linux; (17) Palm OS; (18) Symbian; (19) Tizen; (20) WebOS; (21) Windows Mobile; (22) Windows Phone; (23) Adobe AIR; (24) Adobe Flash; (25) Adobe Shockwave; (26) Binary Runtime Environment for Wireless (BREW); (27) Cocoa (API); (28) Cocoa Touch; (29) Java Platforms; (30) JavaFX; (31) JavaFX Mobile; (32) Microsoft XNA; (33) Mono; (34) Mozilla Prism, XUL and XULRunner; (35) .NET Framework; (36) Silverlight; (37) Open Web Platform; (38) Oracle Database; (39) Qt; (40) SAP NetWeaver; (41) Smartface; (42) Vexi; and (43) Windows Runtime.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices, and/or exemplary inventive computer-based components of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, smart watch, or any other reasonable mobile electronic device.

As used herein, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

The aforementioned examples are, of course, illustrative and not restrictive.

As used herein, the term “user” shall have a meaning of at least one user. In some embodiments, the terms “user”, “subscriber”, “consumer”, or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

At least some aspects of the present disclosure will now be described with reference to the following numbered clauses.

Clause 1. A computer system comprising:

at least one computer configured to: (i) obtain trial service information upon indication that a user started a service, the trial service information comprising data including two or more of: a period of time, a type of service, and a trial modality; and (ii) monitor related electronic activity of a user during the trial to collect user-specific service feature data;

a machine learning engine or server (which may, e.g., including natural language processing, NLP) configured to extract, via a machine learning model, at least one user-specific feature vector from the user-specific service feature data;

wherein the at least one computer is configured to:
obtain and process a plurality of feature vectors based at least in part on:
   (i) user-specific historical trial information of the user; and
   (ii) other service information associated with service trial activities of other users that bear a relationship to the trial, the user, or both;
compare the user-specific feature vector of the user with the plurality of feature vectors;
predict, based on the comparison, i) a user-specific predicted future usage of the service and ii) a user-specific future action regarding the service, the trial, or both;
determine a trial-specific recommended option based at least in part on the comparison;
provide, to a computing device associated with the user, a computer instruction configured to cause a user-specific graphical user interface to be displayed on a screen of the computing device, wherein the user-specific graphical user interface comprising a graphical user interface element allowing the user to select the trial-specific recommended option; and
automatically execute the trial-specific recommended option upon receiving an indication identifying the selection of the trial-specific recommended option by the user.

Clause 2. The system of clause 1 or the innovation(s) of any other clause herein, wherein features of the feature vector include a pattern of usage, tendency regarding responsiveness to promotional materials offered, a tendency to invite another user to try the service, and/or other user and trial- or service-related information.

Clause 3. The system of clause 1 or the innovation(s) of any other clause herein, wherein the user-specific service feature data comprises three or more of: extent that the service is accessed or used during the trial, quantity of user logins, length of the user logins, parameters of the logins (e.g., login time, login date, a login IP address, etc.), transaction/spending activity associated with the logins including one or both of quantity of actions and a range or extent (e.g., cost- or otherwise, etc.) of the actions, and non-spending activity associated with the logins, and/or as otherwise set forth herein.

Clause 4. The system of clause 1 or the innovation(s) of any other clause herein, wherein the trial-specific recommended option comprises a recommendation for proceeding based on the predicted usage, wherein the recommended option is determined via assessing potential options comprised of proceeding with the service, canceling the trial, and extending the trial.

Clause 5. The system of clause 1 or the innovation(s) of any other clause herein, wherein obtaining and processing the plurality of feature vectors includes:

accessing a collection of electronic communication messages associated with the user; and

parsing electronic communication messages in the collection to identify the indication that the user has started the trial of the service.

Clause 6. The system of clause 1 or the innovation(s) of any other clause herein, wherein the at least one computer is further configured to predict a trial of a new service to the user based on the vector of features of the user.

Clause 7. The system of clause 1 or the innovation(s) of any other clause herein, wherein the machine learning engine or server is configured to process actions associated with access to the service including at least one of: a purchase transaction, a fund transfer action, an upgrade action, a viewing action, a click-through action on a recommended service item, an action by the user associated with changing type of or access to the service, an action by the user associated with terminating the service, and/or an action by the user associated with putting the service on hold, and/or other actions as otherwise disclosed herein.

Clause 8. The system of clause 1 or the innovation(s) of any other clause herein, wherein the recommended option comprises at least an option for: an extension duration for the trial of the service, an amount of cost discount for a subscription to the service, and an upgrade option to the service.

Clause 9. The system of clause 1 or the innovation(s) of any other clause herein, wherein one or both of determining the predicted usage and providing the recommended option further comprises comparing feature vectors of users associated with a plurality of services other than the service of the trial.

Clause 10. The system of clause 1 or the innovation(s) of any other clause herein, wherein the at least one computer is further configured to:

process service trial activities of other users that bear relation to the trial or the user including activities associated with individuals who have one or more of: (i) started trials of the service in the past, (ii) subscribed to the service in the past, and (iii) accepted extension of trials of the service in the past.

Clause 11. The system of clause 1 or the innovation(s) of any other clause herein, wherein the machine learning model comprises analysis of time-series behavior involving one or both of DTW (dynamic time warping) or recurrent neural network processing.

Clause 12. The system of clause 1 or the innovation(s) of any other clause herein, wherein the at least one computer is further configured to:

implement a browser extension application to obtain one or both of the trial service information or the user features.

Clause 13. A computer-implemented method comprising:

obtaining, by at least one computer, trial service information upon indication that a user started a trial of a service, the trial service information comprising data including two or more of: a trial period, service type information, and a trial modality;

monitoring, by the at least one computer, service-related electronic activity of the user during the trial to collect user-specific service feature data;

extracting, by the at least one computer, utilizing a machine learning model (which may, inter alia, utilize and/or involve a natural language processing, NLP, engine or machine, etc.), at least one user-specific feature vector from the user-specific service feature data;

obtaining, by the at least one computer, a plurality of feature vectors based at least in part on:
(i) user-specific historical trial information of the user and
(ii) other service information associated with service trial activities of other users that bear a relationship to the trial, the user, or both;

comparing, by the at least one computer, the user-specific feature vector of the user with the plurality of feature vectors;

predicting, by the at least one computer, based on the comparison, i) a user-specific predicted future usage of the service and ii) a user-specific future action regarding the service, the trial, or both;

determining, by the at least one computer, a trial-specific recommended option based at least in part on the comparison;

providing, by the at least one computer, to a computing device associated with the user, a computer instruction configured to cause a user-specific graphical user interface to be displayed on a screen of the computing device, wherein the user-specific graphical user interface comprising a graphical user interface element allowing the user to select the trial-specific recommended option; and

automatically executing, by the at least one computer, the trial-specific recommended option upon receiving an indication identifying the selection of the trial-specific recommended option by the user.

Clause 14. The method of clause 13 or the innovation(s) of any other clause herein, wherein features of the feature vector include a pattern of usage, a tendency responsive to promotional materials offered, a tendency to invite another user to try the service, and/or as otherwise set forth herein.

Clause 15. The method of clause 13 or the innovation(s) of any other clause herein, wherein the user-specific service feature data comprises one or more of, two or more of, three or more of, or four or more of: extent that the service is used during the trial, quantity of user logins, length of the user logins, parameters of the logins (login time, login date, a login IP address, etc.), transaction/spending activity associated with the logins including one or both of quantity of actions and a range/extent of the actions (e.g., with regard to cost, other transaction details, etc.), and/or non-spending activity associated with the logins, and/or other customer-specific usage activity or parameters associated with login, activity, and/or use.

Clause 16. The method of clause 13 or the innovation(s) of any other clause herein, wherein the trial-specific recommended option comprises a recommendation for proceeding based on the predicted usage, wherein the recommended option is determined via assessing potential options comprised of proceeding with the service, canceling the trial, and extending the trial.

Clause 17. The method of clause 13 or the innovation(s) of any other clause herein, wherein the obtaining an indication that a user starts a trial of a service comprises:

accessing a collection of electronic communication messages associated with the user; and

parsing electronic communication messages in the collection to identify the indication that the user has started the trial of the service.

Clause 18. The method of clause 15 or the innovation(s) of any other clause herein, wherein information regarding the trial is identified by identifying information relating to a service name, a service duration, and/or service cost.

Clause 19. The method of clause 13 or the innovation(s) of any other clause herein, further comprising predicting a trial of a new service to the user based on the vector of features of the user.

Clause 20. The method of clause 13 or the innovation(s) of any other clause herein, wherein the actions associated with access to the service comprise at least one of: a purchase transaction, a fund transfer action, an upgrade action, a viewing action, a click-through action on a recommended service item, an action by the user associated with changing type of or access to the service, an action by the user associated with terminating the service, an action by the user associated with putting the service on hold, and/or one or more other actions as otherwise set forth herein.

Clause 21. The method of clause 13 or the innovation(s) of any other clause herein, wherein the extracting the feature vector for the user further comprises:
implementing the machine learning model via xgboost modeling that utilizes multiple trees using gradient boosting technique(s) in order to generalize and learn from the historical user data.

Clause 22. The method of clause 13 or the innovation(s) of any other clause herein, wherein the recommended option comprises at least an option for: an extension duration for the trial of the service, an amount of cost discount for a subscription to the service, and an upgrade option to the service.

Clause 23. The method of clause 13 or the innovation(s) of any other clause herein, wherein one or both of determining the predicted usage and providing the recommended option further comprises comparing feature vectors of users associated with a plurality of services other than the service of the trial.

Clause 24. The method of clause 13 or the innovation(s) of any other clause herein, wherein the service trial activities of the other users that bear relation to the trial or the user include activities associated with individuals who have one or more of: (i) started trials of the service in the past, (ii) subscribed to the service in the past, and (iii) accepted extension of trials of the service in the past.

Clause 25. The method of clause 13 or the innovation(s) of any other clause herein, wherein the machine learning model comprises analysis of time-series behavior involving one or both of DTW (dynamic time warping) or recurrent neural network processing.

Clause 26. The method of clause 13 or the innovation(s) of any other clause herein, further comprising:

implementing a browser extension application to obtain one or both of the trial service information or the user features.

While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

1. A system comprising:
at least one computer configured to: (i) obtain trial service information upon indication that a user started a trial for a service, the trial service information comprising data including two or more of: a period of time, a type of service, and a trial modality; and (ii) monitor at least one trial-related electronic activity of a user during the trial to collect user-specific service feature data;
a machine learning engine configured to extract, via a machine learning model, at least one user-specific feature vector from the user-specific service feature data;
wherein the at least one computer is further configured to:
obtain and process a plurality of feature vectors based at least in part on:
(i) user-specific historical trial information of the user, and
(ii) other service information associated with service trial activities of other users that bear a relationship to the trial, the user, or both;
execute a comparison of the user-specific feature vector of the user with the plurality of feature vectors;
predict, based on the comparison, i) a user-specific predicted future usage of the service and ii) a user-specific future action regarding the service, the trial, or both; determine a trial-specific recommended option based at least in part on the comparison;
provide, to a computing device associated with the user, a computer instruction configured to cause a user-specific graphical user interface to be displayed on a screen of the computing device, wherein the user-specific graphical user interface comprising a graphical user interface element allowing the user to select the trial-specific recommended option; and
automatically execute the trial-specific recommended option upon receiving an indication identifying the selection of the trial-specific recommended option by the user.

2. The system of claim 1 wherein features of the feature vector include one or more of: a pattern of usage, tendency regarding responsiveness to promotional materials offered, tendency to invite another user to try the service, frequency of service usage, recency of usage, and/or whether or not the user checks subscriptions/prices of the service via certain means, such as through the link provided in the service.

3. The system of claim 1 wherein the user-specific service feature data comprises three or more of: extent that the service is accessed or used during the trial, quantity of user logins, length of the user logins, parameters of the logins, transaction/spending activity associated with the logins including one or both of quantity of actions and a range or extent (e.g., cost or otherwise, etc.) of the actions, or non-spending activity associated with the logins, and/or other customer-specific usage activity or parameters associated with login, activity, and/or use.

4. The system of claim 1 wherein the trial-specific recommended option comprises a recommendation for proceeding based on the predicted usage, wherein the recommended option is determined via assessing potential options comprised of proceeding with the service, canceling the trial, and extending the trial.

5. The system of claim 1, wherein obtaining and processing the plurality of feature vectors includes:
accessing a collection of electronic communication messages associated with the user; and
parsing electronic communication messages in the collection to identify the indication that the user has started the trial of the service.

6. The system of claim 1, wherein the at least one computer is further configured to:
predict a trial of a new service to the user based on the vector of features of the user.

7. The system of claim 1, wherein the machine learning engine or server is configured to process actions associated with access to the service including at least one of: a purchase transaction, a fund transfer action, an upgrade action, a viewing action, a click-through action on a recommended service item, an action by the user associated with changing type of or access to the service, an action by the user associated with terminating the service, and/or an action by the user associated with putting the service on hold.

8. The system of claim 1, wherein the recommended option comprises at least an option for: an extension duration for the trial of the service, an amount of cost discount for a subscription to the service, and an upgrade option to the service.

9. The system of claim 1, wherein one or both of determining the predicted usage and providing the recommended option further comprises comparing feature vectors of users associated with a plurality of services other than the service of the trial.

10. The system of claim 1 wherein the at least one computer is further configured to:
process service trial activities of other users that bear relation to the trial or the user including activities associated with individuals who have one or more of: (i) started trials of the service in the past, (ii) subscribed to the service in the past, and (iii) accepted extension of trials of the service in the past.

11. The system of claim 1 wherein the machine learning model comprises analysis of time-series behavior involving one or both of DTW (dynamic time warping) or recurrent neural network processing.

12. The system of claim 1 wherein the at least one computer is further configured to:
implement a browser extension application to obtain one or both of the trial service information or the user features.

13. A computer-implemented method comprising:
obtaining, by at least one computer, trial service information upon indication that a user started a trial of a service, the trial service information comprising data including two or more of: a trial period, service type information, and a trial modality;
monitoring, by the at least one computer, service-related electronic activity of the user during the trial to collect user-specific service feature data;
extracting, by the at least one computer, utilizing one or both of a machine learning model or natural language processing (NLP), at least one user-specific feature vector from the user-specific service feature data;
obtaining, by the at least one computer, a plurality of feature vectors based at least in part on:
(i) user-specific historical trial information of the user and
(ii) other service information associated with service trial activities of other users that bear a relationship to the trial, the user, or both;
executing, by the at least one computer, a comparison of the user-specific feature vector of the user with the plurality of feature vectors;
predicting, by the at least one computer, based on the comparison, one or both of i) a user-specific predicted future usage of the service, and/or ii) a user-specific future action regarding the service, the trial;
determining, by the at least one computer, a trial-specific recommended option based at least in part on the comparison;
providing, by the at least one computer, to a computing device associated with the user, a computer instruction configured to cause a user-specific graphical user interface to be displayed on a screen of the computing device, wherein the user-specific graphical user interface comprising a graphical user interface element allowing the user to select the trial-specific recommended option; and
automatically executing, by the at least one computer, the trial-specific recommended option upon receiving an indication identifying the selection of the trial-specific recommended option by the user.

14. The method of claim 13 wherein features of the feature vector include one or more of: a pattern of usage, a tendency responsive to promotional materials offered, a tendency to invite another user to try the service, frequency of service usage, recency of usage, or whether or not the user checks subscriptions/prices of the service via certain means, such as through the link provided in the service.

15. The method of claim 13 wherein the user-specific service feature data comprises three or more of: extent that the service is used during the trial, quantity of user logins, length of the user logins, parameters of the logins (login time, login date, a login IP address, etc.), transaction/spending activity associated with the logins including one or both of quantity of actions and a range/extent of the actions, and non-spending activity associated with the logins, and/or other customer-specific usage activity or parameters associated with login, activity, and/or use.

16. The method of claim 13 wherein the trial-specific recommended option comprises a recommendation for proceeding based on the predicted usage, wherein the recommended option is determined via assessing potential options comprised of proceeding with the service, canceling the trial, and extending the trial.

17. The method of claim 13, wherein the obtaining an indication that a user starts a trial of a service comprises:
accessing a collection of electronic communication messages associated with the user; and
parsing electronic communication messages in the collection to identify the indication that the user has started the trial of the service.

18. The method of claim 15, wherein information regarding the trial is identified by identifying information relating to a service name, a service duration, and/or service cost.

19. The method of claim 13, further comprising predicting a trial of a new service to the user based on the vector of features of the user.

20. The method of claim 13, wherein the actions associated with access to the service comprise at least one of: a purchase transaction, a fund transfer action, an upgrade action, a viewing action, a click-through action on a recommended service item, an action by the user associated with changing type of or access to the service, an action by the user associated with terminating the service, and/or an action by the user associated with putting the service on hold.

21.-26. (canceled)
